(19) United States
(12) Patent Application Publication
(10) Pub. No.: US 2026/0103288 A1
(43) Pub. Date: Apr. 16, 2026

(54) Drone Taxi System for Ground-Level Personal Transportation

(71) Applicant: Travis Ryan Henderson, Spokane, WA (US)

(72) Inventor: Travis Ryan Henderson, Spokane, WA (US)

(21) Appl. No.: 19/416,337

(22) Filed: Dec. 11, 2025

Related U.S. Application Data
(60) Provisional application No. 63/734,618, filed on Dec. 16, 2024.

(51) Int. Cl. B64D 25/06; B64U 10/14; B64U 20/30; B64U 101/61

(52) U.S. Cl. CPC B64D 25/06; B64U 10/14; B64U 20/30; B64U 2101/61

(57) ABSTRACT

Systems and methods for a drone taxi system for ground-level transportation are disclosed. The system includes a multi-rotor drone apparatus capable of carrying individuals at low altitudes, approximately 1-2 feet off the ground. The system includes advanced stabilization and obstacle detection capabilities, a secure harness with a quick-release mechanism, and an inflatable safety vest that activates during emergencies. Controlled via a smartphone application, the system enables users to request drone rides, map routes, and view trip status in real-time. The drone ensures safe and efficient transit over short distances, combining the functionality of ride-sharing platforms with the experience of low-altitude travel. This system addresses urban mobility challenges, offering a safe, efficient, and eco-friendly alternative to traditional ground-based transportation methods while minimizing risks and maximizing convenience for users.

### BACKGROUND

The rise of personal transportation solutions such as ride-sharing and micromobility devices indicates a strong demand for efficient means of travel. Current systems, such as scooters and bicycles, have limitations in terrain adaptability, user experience, and safety features. Existing ground-based methods often struggle with obstacles and traffic or poor road conditions, like mud, snow, ice, and potholes. These ground-level limitations have prevented existing technologies from providing a truly safe and efficient short-distance transit solution. These limitations often result in inefficient travel times and safety risks.

### SUMMARY

The present disclosure is directed to systems and methods for a drone taxi system for ground-level transportation. The disclosed techniques address limitations in terrain adaptability and user safety found in conventional micromobility devices.

In aspects, a drone taxi system includes a drone apparatus including a multi-rotor configuration and a central housing. The system includes a secure harness system integrated with the drone apparatus and is configured to transport a user at a low altitude. The system may further include an inflatable safety vest configured to be worn by the user, having an inflation mechanism. The system is further supported by a ride-request application that allows users to summon a drone, similar to existing ride-sharing services. This approach may allow for the efficient exploration of short-distance travel in urban and semi-urban environments while maintaining a high degree of safety through redundant protection mechanisms.

In example implementations, a method for personal transportation is described. The method includes receiving, via a smartphone application, a request for a ride including a pickup location and a drop-off location. The method further includes dispatching a drone apparatus to the pickup location. The method also includes performing a safety check, the safety check including confirming a status of a secure harness system and an inflatable safety vest. The method still further includes transporting a user via the drone apparatus to the drop-off location.

### BRIEF DESCRIPTION OF DRAWINGS

Apparatuses of and techniques for a drone taxi system for ground-level personal transportation are described with reference to the following drawings. The same numbers are used throughout the drawings to reference like features and components.

FIG. 1 illustrates an example operating environment in which techniques for a drone taxi system for ground-level personal transportation can be implemented.

FIG. 2 illustrates a top view of a drone apparatus of FIG. 1 for a drone taxi system for ground-level personal transportation.

FIG. 3 illustrates an example implementation of a secure harness system of FIG. 1 for a drone taxi system for ground-level personal transportation.

FIG. 4 illustrates example user interfaces for a smartphone application for implementing aspects of a drone taxi system for ground-level personal transportation.

### DETAILED DESCRIPTION

### Overview

This document describes a drone taxi system that enables individuals to travel from one point to another at low altitudes. Conventional ground transport is often limited by terrain, and high-altitude transport presents significant regulatory and safety hurdles. The present disclosure utilizes a drone apparatus generally comprising a multi-rotor configuration with high thrust capacity, designed to lift and carry a person, such as one weighing up to 250 pounds.

Key features of the apparatus include a rotor system, such as a quad-rotor or octa-rotor setup, with shrouded propellers for increased safety and reduced noise. The apparatus utilizes real-time gyroscopic stabilization and obstacle avoidance sensors to maintain smooth operation over uneven terrain. Navigation is handled via GPS-enabled autonomous navigation with fail-safe landing capabilities. The apparatus is powered by a rechargeable lithium-polymer battery pack or a hybrid power system for extended operation times.

To ensure passenger safety, the drone can include a secure harness and attachment system. This system includes padded, adjustable straps to accommodate a range of body sizes and manual and automatic quick-release features to ensure rapid detachment in emergencies. Additionally, each user is required to wear an inflatable safety vest modeled after airbag vests used in motorcycle safety. The vest features an inflation mechanism triggered by a gas cartridge upon detecting sudden altitude drops or emergency situations. While some implementations may include a compressed gas canister containing inert gases such as carbon dioxide (CO₂), nitrogen (N₂), or argon, other implementations may utilize a chemical gas generator (e.g., a pyrotechnic inflator) capable of rapidly producing gas upon activation. In further aspects, the inflation mechanism may include a multi-stage inflator, where a first stage provides partial inflation for minor stability loss, and a second stage provides full inflation upon detection of a collision or free-fall. It provides full torso and neck protection to minimize injury in the event of a crash or abrupt landing.

The system can be controlled via a smartphone application, which provides an interface similar to ride-sharing platforms. Key functionalities include drone summoning, where users enter pickup and drop-off locations to request a drone. The app can perform route mapping, which calculates efficient routes while considering obstacles and terrain. Furthermore, the app includes safety checks where users must confirm the correct fit of their safety harness and vest via an integrated checklist. It also provides visualization of the drone's location and estimated arrival time.

### Example Operating Environment

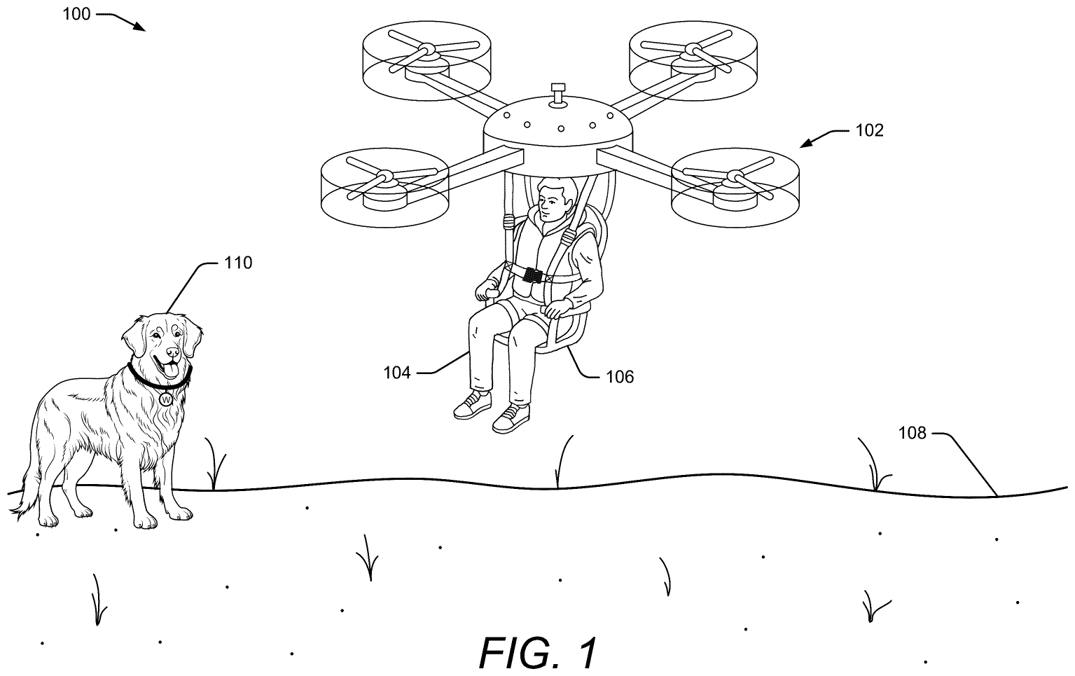

FIG. 1. illustrates an operating environment 100 for a drone taxi system for ground-level personal transportation. A drone apparatus 102 is configured to support and transport a user 104. The user 104 is secured to the drone apparatus 102 via a secure harness system 106, which is integrated to safely attach the user 104 to the drone apparatus 102 during transit. In operation, the drone apparatus 102 is capable of hovering and traveling while maintaining the user 104 at a predetermined low altitude above a ground 108. While approximately 1-2 feet off the ground 108 can be utilized in some configurations to minimize fall risk, the system can be adaptable to other ranges. For example, a low altitude mode may maintain an altitude of 2 to 12 inches for ultra-low-profile transit, while a high-altitude mode may elevate the user to 2 to 6 feet to clear curbs, small shrubs, uneven terrain, or other obstacles. As illustrated, a dog 110 may be an obstacle that the drone apparatus 102 has to avoid. To further ensure safety, the system may correlate speed limits to these altitude modes. For instance, a flight controller may restrict the drone apparatus to a lower speed (e.g., 5 miles per hour (mph)) when in the low altitude mode and permit higher speeds (e.g., 15 mph) when in the high altitude mode. To accommodate a wide range of passengers, the drone apparatus 102 is engineered with a high thrust capacity to lift a user 104 weighing up to 250 pounds. Generally, the drone apparatus 102 includes a multi-rotor configuration equipped with high-power, low-noise rotors, and advanced stabilization technology to facilitate safe personal transport.

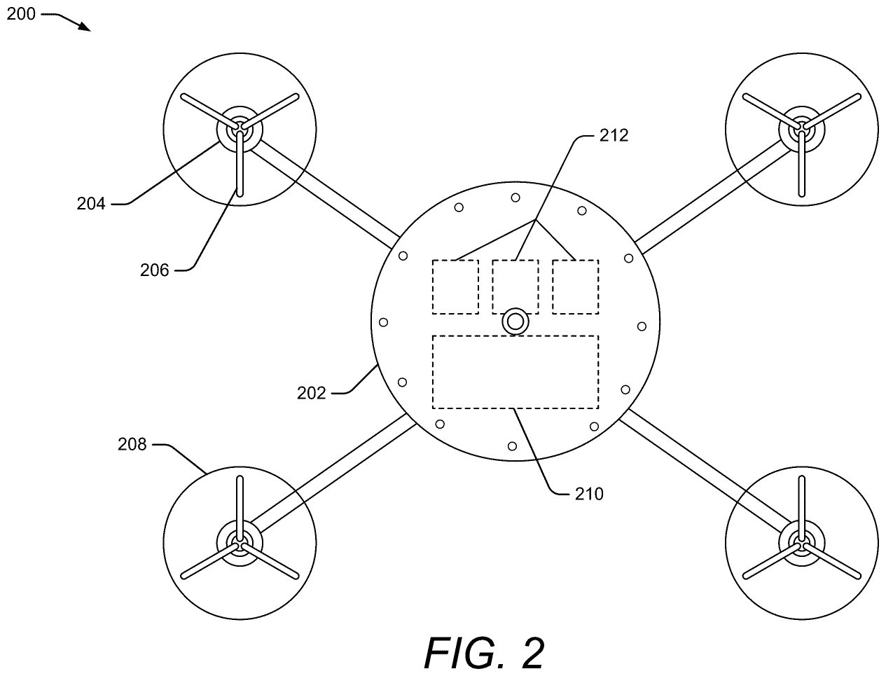

FIG. 2 illustrates a top view 200 of the drone apparatus 102 of FIG. 1. The drone apparatus 102 includes a central housing 202 connected to one or more rotors 204. Each of the one or more rotors 204 includes one or more propellers 206 surrounded by shrouding 208 designed for increased safety and reduced noise by preventing accidental contact with the spinning blades and dampening sound output. Internal components housed within or on the central housing 202 include a battery 210, such as a rechargeable lithium-polymer pack for extended operation or a hybrid power system to support longer flight durations. The central housing 202 further includes one or more sensors 212. The one or more sensors 212 may include gyroscopic sensors, obstacle avoidance sensors, and Global Positioning System (GPS) modules for autonomous navigation with fail-safe landing capabilities to maintain operation of the drone apparatus 102 over uneven terrain. In specific sensor implementations, the obstacle avoidance sensors can include a fusion of light detection and ranging (LIDAR) units for high-resolution environmental mapping and ultrasonic rangefinders for transparent object detection. Furthermore, the stabilization sensors may include downward-facing optical flow cameras to track ground texture, enabling position holding in environments where GPS signals are degraded (e.g., urban canyons).

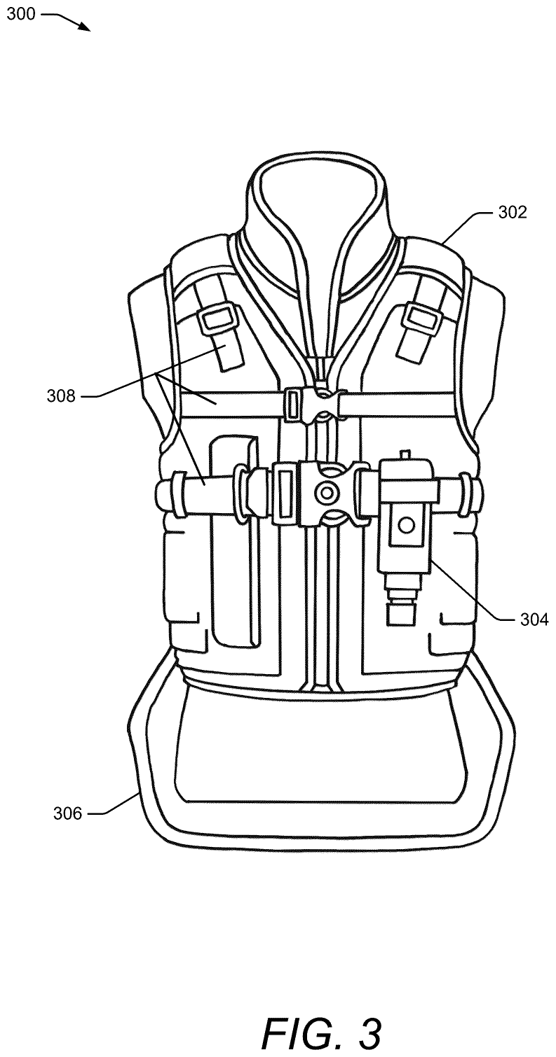

FIG. 3 illustrates an implementation 300 of the secure harness system 106 of FIG. 1. The secure harness system 106 includes an inflatable safety vest 302 with torso and neck protection. The inflatable safety vest 302 further includes a CO₂ cartridge 304, which can serve as an inflation mechanism triggered upon detecting sudden altitude drops or emergencies. To prevent false positives, this detection may utilize sensor fusion, comparing data from accelerometers (detecting g-force), radar (detecting velocity and/or proximity), camera (optical, infrared for object detection), and barometric pressure sensors (detecting pressure change) before triggering the inflation mechanism. The secure harness system 106 further includes a seat 306 which can provide a load distribution structure to support the weight of a user (e.g., the user 104 of FIG. 1) and maximize comfort during transit. The seat 306 may further include integrated load cells to perform a pre-flight weight check, ensuring the user is within the weight limit and centered relative to the center of gravity. The user can be secured into the inflatable safety vest 302 and the seat 306 through one or more adjustable straps 308. The one or more adjustable straps 308 can be padded to accommodate a range of body sizes. For example, a user can don the inflatable safety vest 302 and fasten the adjustable straps 308 prior to the drone taking off. If the system detects an emergency (e.g., via the one or more sensors 212 of FIG. 2), the CO₂ cartridge 304 can activate automatically to inflate the vest, thereby protecting the user's torso and neck. While not illustrated, safety mechanisms can be built into the drone-based personal transportation system, which replace or supplement the noted inflatable safety vest 302, such as a fixed or semi-adjustable safety cage, which may itself also include inflatable aspects, included those between the cage and the rider.

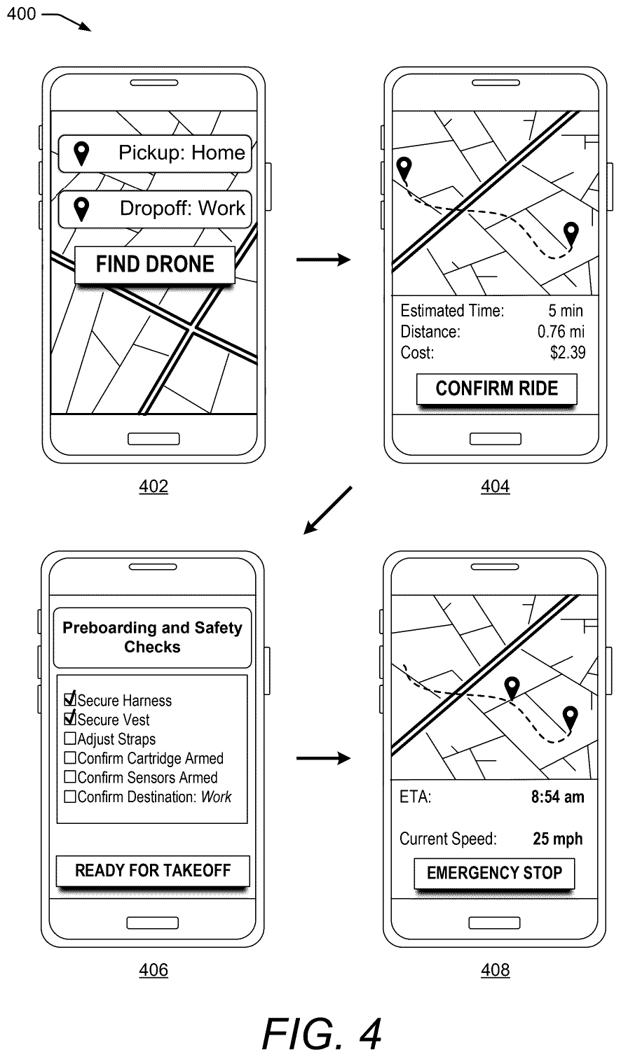

FIG. 4 illustrates a user-interface implementation 400 for a ride-request application used to control the drone apparatus 102 of FIG. 1. Screen 402 displays a drone summoning interface where a user (e.g., the user 104 of FIG. 1) can enter a pickup and a drop-off location to find a drone. Screen 404 displays a route mapping interface that calculates a route, an estimated time, distance, and cost of the ride, and allows the user to confirm the ride. Screen 406 displays a preboarding and safety checklist. This checklist requires the user to confirm items by checking things such as the harness, the vest, the straps, and the sensors before allowing the drone to takeoff. This can ensure that safety protocols are followed before the propulsion systems are engaged.

Screen 408 displays a trip status interface. This screen can provide a visualization of the drone's location, the estimated time of arrival (ETA), and the current speed, while also offering an emergency stop function. For example, consider a user who wants to find a drone to head to work. The user initiates a transport request by inputting “Home” as the pickup location and “Work” as the drop-off location on screen 402. Upon reviewing the cost and time on screen 404, the user selects “Confirm Ride.” Once the drone arrives, the user interacts with screen 406 to digitally verify that the harness is secure and the vest is fitted. During the flight, the user views screen 408 to view progress, potentially pressing the “Emergency Stop” button if an obstacle is observed that the sensors (e.g., the one or more sensors 212 of FIG. 2) might have missed.

In some implementations, a user may be provided with controls allowing the user to make an election as to whether systems, programs, or features described herein may enable collection of user information, such as current location or route history. Thus, the user may have control over what information is collected about the user and how that information is used.

### EXAMPLES

Various examples are described herein, including a drone-based personal transportation system (example 1), which includes a drone apparatus including a multi-rotor configuration. The system also includes a secure harness system integrated with the drone apparatus. The system is further configured to transport a user at a low altitude.

Example 2: The system of example 1 further includes an inflatable safety vest configured to be worn by the user, the inflatable safety vest having an inflation mechanism.

Example 3: The system of example 2, where the inflation mechanism is a gas deployment mechanism configured to activate automatically upon detecting a sudden altitude drop.

Example 4: The system of example 3, wherein the gas deployment mechanism comprises a pressurized canister containing at least one of carbon dioxide, nitrogen, or argon.

Example 5: The system of example 3, wherein the gas deployment mechanism uses a chemical gas generator capable of rapidly producing gas upon activation.

Example 6: The system of example 1, wherein the inflation mechanism is a cartridge-triggered mechanism.

Example 7: The system of example 1 further includes a smartphone application configured to communicate with the drone apparatus.

Example 8: The system of example 7, where the smartphone application is further configured to display a pre-flight safety checklist.

Example 9: The system of example 8, where the pre-flight safety checklist includes user confirmation of the secure harness system and an inflatable safety vest.

Example 10: The system of example 1, where the multi-rotor configuration includes one or more shrouded propellers.

Example 11: The system of example 1, wherein the central housing includes a battery.

Example 12: The system of example 1, where the drone apparatus is configured to lift a weight of up to 250 pounds.

Example 13: The system of example 1, wherein the low altitude is at a height suitable for ground-level obstacle avoidance.

Example 14: The system of example 1, where the low altitude is between 12 and 24 inches above a ground level.

Example 15: The system of example 1, where the low altitude is between 2 inches and 12 inches above a ground level.

Example 16: The system of example 1, where the low altitude is between 2 feet and 6 feet above a ground level.

Example 17: A method for personal transportation, the method including receiving, via a smartphone application, a request for a ride including a pickup location and a drop-off location. The method also includes dispatching a drone apparatus to the pickup location. The method further includes performing a safety check, the safety check including confirming a status of a secure harness system and an inflatable safety vest. The method still further includes transporting a user via the drone apparatus to the drop-off location.

### Conclusion

Unless context dictates otherwise, use herein of the word “or” may be considered use of an “inclusive-or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, c-c-c, and a-b-b-c or any other ordering of a, b, and c). Further, items represented in the accompanying figures and terms discussed herein may be indicative of one or more items or terms, and thus reference may be made interchangeably to single or plural forms of the items and terms in this written description.

Although concepts of a drone taxi system for ground-level personal transportation have been described in language specific to techniques and/or systems, it is to be understood that the subject of the appended claims is not necessarily limited to the specific techniques or methods described. Rather, the specific techniques and methods are disclosed as example implementations for a drone taxi system for ground-level personal transportation.

What is claimed is:

1. A drone-based personal transportation system comprising:
a drone apparatus comprising a multi-rotor configuration and a central housing; and
a secure harness system integrated with the drone apparatus, and wherein the drone-based personal transportation system is configured to transport a user at a low altitude.

2. The system of claim 1, further comprising an inflatable safety vest configured to be worn by the user, the inflatable safety vest having an inflation mechanism.

3. The system of claim 2, wherein the inflation mechanism is a gas deployment mechanism configured to activate automatically upon detecting a sudden altitude drop.

4. The system of claim 1, further comprising a smartphone application configured to communicate with the drone apparatus.

5. The system of claim 4, wherein the smartphone application is further configured to display a pre-flight safety checklist.

6. The system of claim 5, wherein the pre-flight safety checklist includes user confirmation of the secure harness system and an inflatable safety vest.

7. The system of claim 1, wherein the multi-rotor configuration includes one or more shrouded propellers.

8. The system of claim 1, wherein the central housing includes a battery.

9. The system of claim 1, wherein the drone apparatus is configured to lift a weight of up to 250 pounds.

10. The system of claim 1, wherein the low altitude is at a height suitable for ground-level obstacle avoidance.

11. The system of claim 1, wherein the central housing includes one or more obstacle avoidance sensors.

12. The system of claim 1, wherein the central housing includes one or more gyroscopic stabilization sensors.

13. The system of claim 1, wherein the central housing includes a global positioning system (GPS) module configured for autonomous navigation.

14. A method for personal transportation, the method comprising:
receiving, via a smartphone application, a request for a ride including a pickup location and a drop-off location;
dispatching a drone apparatus to the pickup location;
performing a safety check, the safety check including confirming a status of a secure harness system and an inflatable safety vest; and
transporting a user via the drone apparatus to the drop-off location.
